(19) United States
(12) Patent Application Publication
(10) Pub. No.: US 2016/0117016 A1
(43) Pub. Date: Apr. 28, 2016

(54) HIGH-TRANSPARENCY AND HIGH-SENSITIVITY TOUCH PATTERN STRUCTURE OF CAPACITIVE TOUCH PANEL

(71) Applicant: FocalTech Systems Co., Ltd., Hsinchu (TW)

(72) Inventors: Hai-Ming WU, Hsinchu (TW); Yen-Lin HUANG, Hsinchu (TW)

(21) Appl. No.: 14/854,144

(22) Filed: Sep. 15, 2015

(30) Foreign Application Priority Data
Oct. 27, 2014 (TW) 103136971

(51) Int. Cl. G06F 3/044; G06F 3/041; G06F 1/16

(52) U.S. Cl. CPC G06F 3/044; G06F 1/16; G06F 3/0416

(57) ABSTRACT

A high-transparency and high-sensitivity touch pattern structure of capacitive touch panel is formed on a surface of a substrate. A plurality of first conductive groups are horizontally arranged along a first direction. Each first conductive group has a plurality of first conductive units. Each first conductive unit is composed of one first conductive zigzag line and one first straight line. A plurality of second conductive groups are horizontally arranged along the first direction. Each second conductive group has a plurality of second conductive units. Each second conductive unit is composed of one second conductive zigzag line. The plurality of first conductive units and the plurality of second conductive units form an array of capacitive sensors.

### BACKGROUND OF THE INVENTION

1. Field of the Invention

The present invention relates to touch panels and, more particularly, to a high-transparency and high-sensitivity touch pattern structure of capacitive touch panel.

2. Description of Related Art

The principle of touch panels is based on different sensing manners to detect a voltage, current, acoustic wave, or infrared to thereby detect the coordinate of a touch point on a screen as touched by a finger or other mediums. For example, the sensing manner of a capacitive touch panel is to utilize a capacitance change in an electrostatic combination of the arranged transparent electrodes with the touching part of a human body to generate a current or voltage for detecting the coordinate of the touching part.

FIG. 1 schematically illustrates the structure of a typical capacitive touch panel in which a first array with horizontally arranged conductor lines (X1, X2, X3, . . . ) made of metal material is formed on one side of a substrate (not shown) while a second array with vertically arranged conductor lines (Y1, Y2, Y3, . . . ) made of metal material is formed on the other side of the substrate. The conductor lines (X1, X2, X3, . . . ) in the first array and the conductor lines (Y1, Y2, Y3, . . . ) in the second array are mutually interlaced and overlapped to one another. When a driving circuit 110 generates a driving signal, a detection circuit 120 detects an electric field change on the peripheral sensing capacitance between two electrode plates so as to determine a touch coordinate. However, such a touch structure requires two layers of conductor lines, so that the manufacture process becomes complicated and the cost is high.

FIG. 2 schematically illustrates the structure of a typical capacitive touch panel as described in U.S. Pat. No. 4,550,221 granted to Mabusth in 1985 for a “Touch sensitive control device”. In FIG. 2, the conductive plates 30 are formed as thin metal on a substrate 28 and have a specific shape (such as a diamond shape) by etching As shown in FIG. 2, the conductive plates 30 are formed to have a first array with the conductor lines (X1, X2, X3, . . . , X12) in the horizontal direction, and to have a second array with the conductor lines (Y1, Y2, Y3, . . . , Y12) in the vertical direction. Each of the conductor lines X1-X12 and Y1-Y12 has multiple electrodes which are arranged on the substrate in an interlaced and non-overlapped manner. Each diamond metal plate of the conductor lines Y1-Y12 has at least two edges adjacent to the metal plates of the conductor lines X1-X12, and at most four edges adjacent to those of the conductor lines X1-X12. Also, each diamond metal plate of the conductor lines X1-X12 has at least two edges adjacent to the metal plates of the conductor lines Y1-Y12, and at most four edges adjacent to those of the conductor lines Y1-Y12. When a driving circuit (not shown) generates a driving signal, a detection circuit (not shown) detects an electric field change on the lateral sensing capacitance between the conductor lines Y1-Y12 and the conductor lines X1-X12 so as to determine a touch coordinate. Such a touch structure may simplify the manufacture process by arranging the conductor lines Y1-Y12 and X1-X12 on the same layer. However, it requires a bridge between the diamond metal plates of the conductor lines X1-X12 for an electrical connection, resulting in that the manufacturing cost is increased. In addition, the bridge is prone to be broken, and thus the touch location may become undetectable.

Therefore, it is desirable to provide an improved touch pattern structure of capacitive touch panel to mitigate and/or obviate the aforementioned problems.

### SUMMARY OF THE INVENTION

The object of the present invention is to provide a high-transparency and high-sensitivity touch pattern structure of capacitive touch panel, which can enlarge the sensing area and increase the number of electric lines of force, so as to accurately detect a finger's touch when performing touch detection, and prevent the touch pattern from being visible to human eyes.

In one aspect of the invention, there is provided a high-transparency and high-sensitivity touch pattern structure of capacitive touch panel, formed on a surface of a substrate. The touch pattern structure includes a plurality of first conductive groups, a plurality of second conductive groups, and a plurality of first traces. The plurality of first conductive groups are horizontally arranged along a first direction. Each first conductive group has a plurality of first conductive units. Each first conductive unit is composed of at least one first conductive zigzag line and at least one first straight line. The plurality of second conductive groups are horizontally arranged along the first direction. Each second conductive group has a plurality of second conductive units. Each second conductive unit is composed of at least one second conductive zigzag line. The plurality of second conductive groups and the plurality of first conductive groups are located on the same layer. The plurality of first traces and the plurality of second conductive groups are located on the same layer. Each first trace is coupled to a different second conductive unit. The plurality of first conductive units of the first conductive group are electrically connected together. The plurality of first conductive units and the plurality of second conductive units form an array of capacitive sensors. Each capacitive sensor includes one first conductive unit and one second conductive unit.

In another aspect of the invention, there is provided a touch panel, which includes: a plurality of first conductive units, each of the first conductive units having zigzag line; a plurality of second conductive units, each of the second conductive units having zigzag line; and a controller coupled to the plurality of first conductive units and the plurality of second conductive units for outputting driving signals to drive the plurality of first conductive units, respectively, and receiving electrical signals sensed by the plurality of first conductive units, so as to allow the plurality of first conductive units and the plurality of second conductive units to form capacitive sensors.

Other objects, advantages, and novel features of the invention will become more apparent from the following detailed description when taken in conjunction with the accompanying drawings.

### BRIEF DESCRIPTION OF THE DRAWINGS

FIG. 1 schematically illustrates the structure of a typical capacitive touch panel;

FIG. 2 schematically illustrates the structure of another typical capacitive touch panel;

FIG. 3 is a schematic view of a high-transparency and high-sensitivity touch pattern structure of capacitive touch panel according to one embodiment of the present invention;

FIG. 4 is a schematic view of a first conductive unit according to one embodiment of the present invention;

FIG. 5 is a schematic view of a second conductive unit according to one embodiment of the present invention;

FIG. 6 is another schematic view of the high-transparency and high-sensitivity touch pattern structure of capacitive touch panel according to one embodiment of the present invention; and

FIG. 7 is another schematic view of the first conductive unit, second conductive unit, and dummy electrode according to one embodiment of the present invention.

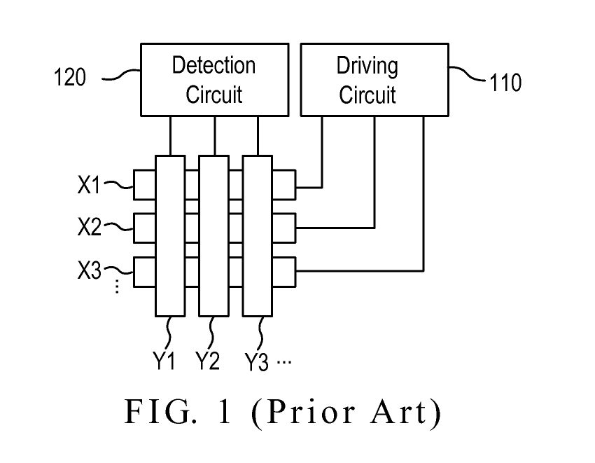

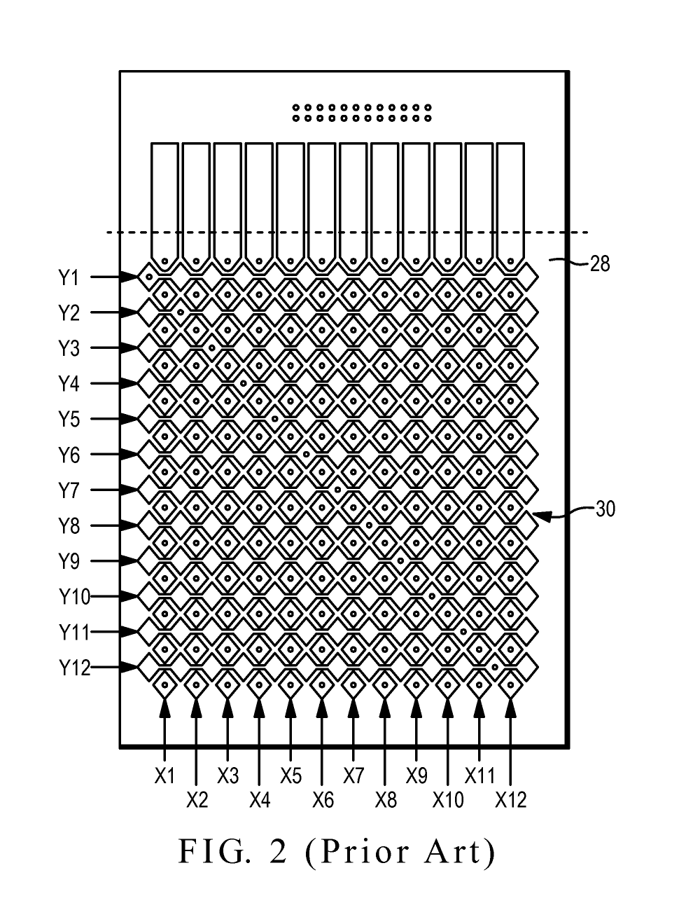

### DETAILED DESCRIPTION OF THE PREFERRED EMBODIMENT

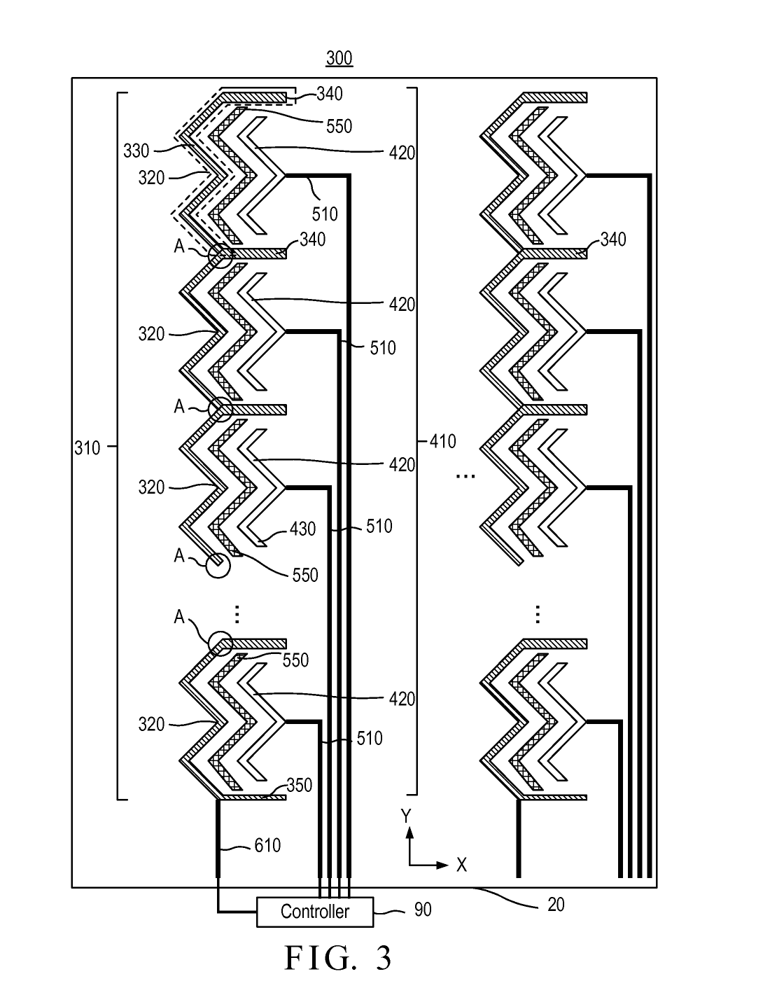

FIG. 3 is a schematic view of a high-transparency and high-sensitivity touch pattern structure 300 of capacitive touch panel according to one embodiment of the present invention. The high-transparency and high-sensitivity touch pattern structure 300 is formed on a surface of a substrate 20. The touch pattern structure 300 includes a plurality of first conductive groups 310, a plurality of second conductive groups 410, and a plurality of first traces 510.

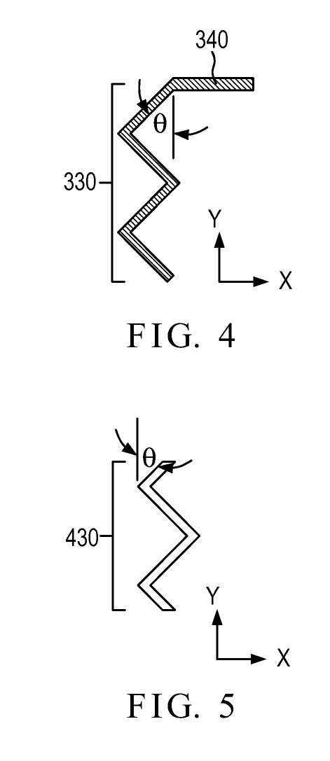

The plurality of first conductive groups 310 are horizontally arranged along a first direction (X-axis direction). Each first conductive group 310 has a plurality of first conductive units 320. FIG. 4 is a schematic view of a first conductive unit 320 according to one embodiment of the present invention. The first conductive unit 320 is composed of at least one first conductive zigzag line 330 and at least one first straight line 340. The plurality of first conductive groups 310 are of the same layer and are disposed on the surface of the substrate 20.

The plurality of second conductive groups 410 are horizontally arranged along the first direction. Each second conductive group 410 has a plurality of second conductive units 420. FIG. 5 is a schematic view of a second conductive unit 420 according to one embodiment of the present invention. The second conductive unit 420 is composed of at least one second conductive zigzag line 430. The plurality of second conductive groups 410 and the plurality of first conductive groups 310 are located on the same layer. The first conductive unit 320 is used as a driving electrode, and the second conductive unit 420 is used as a sensing electrode.

The plurality of first traces 510 and the plurality of second conductive groups 410 are located on the same layer, and each of the first traces 510 is coupled to a different second conductive unit 420, so as to transmit electrical signals sensed by different second conductive units 420 to the controller 90, as shown in FIG. 3

The plurality of first conductive units 320 of the first conductive group 310 are electrically connected together. As Circle A shown in FIG. 3, one first conductive unit 320 is electrically connected to another successive first conductive unit 320 so as to form one first conductive group 310. The first conductive group 310 is further connected to the controller 90 via a second trace 610. In touch detection, the controller 90 applies a touch driving signal to a first column of the plurality of first conductive groups 310 in a first time period, and the plurality of second conductive groups 410 receive the sensing signal. In a second time period, the touch driving signal is applied to a second column of the plurality of first conductive groups 310, and the plurality of second conductive groups 410 receive the sensing signal. Such a process is performed sequentially to the first conductive group 310 in a column, so as to obtain the sensing signals of a sensing plane and further detect touch position of an object.

In other embodiments, the first conductive unit 320 can be used as a sensing electrode, and the second conductive unit 420 can be used as a driving electrode. Accordingly, in touch detection, the controller 90 applies a driving signal to a first row of the second conductive units 420 in a first time period, and the plurality of first conductive groups 310 receive the sensing signal. In a second time period, the driving signal is applied to a second row of the second conductive units 420, and the plurality of first conductive groups 310 receive the sensing signal. Such a process is performed sequentially to the second conductive units 420 in a row, so as to obtain the sensing signals of a sensing plane and further detect touch position of an object.

The plurality of first conductive units 320 and the plurality of second conductive units 420 form an array of capacitive sensors. Each capacitive sensor includes a first conductive unit 320 and a second conductive unit 420.

As shown in FIG. 3, there is no electrical connection between different first conductive groups 310. In addition, there is no electrical connection between different second conductive units 420. Each second conductive unit 420 is connected to the controller 90 through a different first trace 510. The controller 90 can output driving signals to drive different first conductive groups 310, respectively. The controller 90 can receive electrical signals sensed by different second conductive units 420 through corresponding first traces 510. Thus, one first conductive unit 320 and one second conductive unit 420 can form a capacitive sensor.

The last first conductive unit 320 of each first conductive group 310 further includes a second straight line 350. Namely, the first conductive group 310 can be connected to the second trace 610 through the second straight line 350 and further connected to the controller 90.

Please referring to FIG. 3, a dummy electrode 550 is arranged between the first conductive unit 320 and the second conductive unit 420. The dummy electrode 550 is uniformly distributed between the first conductive unit 320 and the second conductive unit 420. The patterns of the first conductive unit 320 and the second conductive unit 420 are not easily seen by human eyes. That is, the dummy electrode 550 can facilitate to eliminate visibility of the first and the second conductive units 320, 420 to human eyes.

As shown in FIG. 3, the plurality of first conductive units 320 are arranged in a second direction (Y-axis direction). The plurality of second conductive units 420 are arranged in the second direction. As shown in FIGS. 4 and 5, the at least one first conductive zigzag line 330 and the at least one second conductive zigzag line 430 are arranged in the second direction. The at least one first straight line 340 is arranged in the first direction. The at least one first conductive zigzag line 330 has an angle θ by intersecting the second direction, and the at least one second conductive zigzag line 430 has the angle θ by intersecting the second direction. The at least one first conductive zigzag line 330 is connected to one end of the at least one first straight line 340. The angle θ is greater than 0 degrees and smaller than 90 degrees.

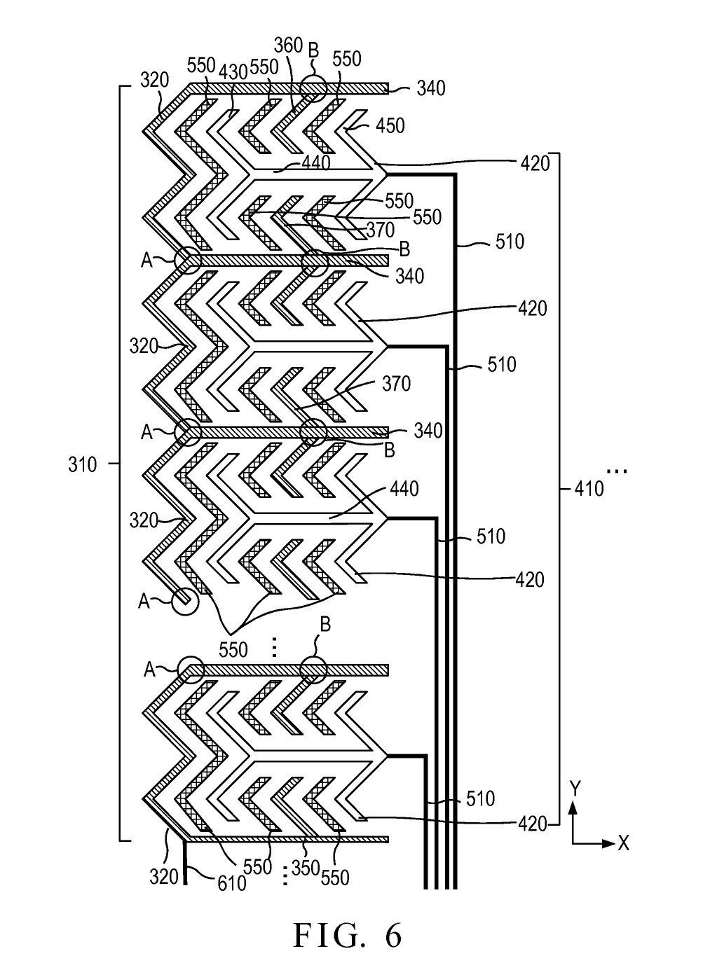

FIG. 6 is a schematic view of a high-transparency and high-sensitivity touch pattern structure 300 of capacitive touch panel according to one embodiment of the present invention, which is similar to that of FIG. 3 except that the first conductive unit 320 further includes a third conductive zigzag line 360 and a fourth conductive zigzag line 370, and the second conductive unit 420 further includes a second straight line 440 and a fifth conductive zigzag line 450.

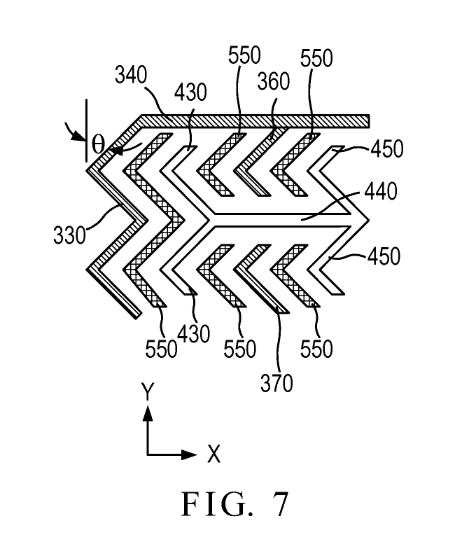

FIG. 7 is a schematic view of the first conductive unit 320, the second conductive unit 420, and the dummy electrode 550 according to the embodiment disclosed in FIG. 6. Different from those embodiments above, the first conductive unit 320 further includes a third conductive zigzag line 360 and a fourth conductive zigzag line 370. As shown in FIGS. 6 and 7, as denoted by Circle B, the third conductive zigzag line 360 is connected to a non-end location of the at least one first straight line 340. In addition, the fourth conductive zigzag line 370 is connected to a non-end location of the at least one first straight line 340 of the next first conductive unit 320. That is, the third and the fourth conductive zigzag lines 360 and 370 can extend from anywhere at the middle of the first straight line 340.

The second conductive unit 420 further includes at least one second straight line 440 and a fifth conductive zigzag line 450. The at least one second conductive zigzag line 430 is connected to one end of the at least one second straight line 440, and the fifth conductive zigzag line 450 is connected to a non-end location of the at least one second straight line 440.

A dummy electrode 550 is arranged between the third and fourth conductive zigzag lines 360 and 370 and the fifth conductive zigzag line 450. The plurality of first conductive units 320, the plurality of second conductive units 420, the plurality of first traces 510, and the plurality of second traces 610 are formed of transparent conductive material. The transparent conductive material is preferably indium tin oxide (ITO), indium zinc oxide (IZO) or other materials, which are well-known to be used in the industry. The first direction is perpendicular to the second direction.

In view of the foregoing description, it is known that according to the embodiments of the present invention the sensing area can be enlarged because the first conductive zigzag line 330 and the second conductive zigzag line 430 are used between the first conductive unit 320 and the second conductive unit 420, such that the number of electric lines of force between the driving electrode and the sensing electrode is increased. Thus, the sensing capacitance is relatively increased to enable the detection circuit to easily detect an accurate touch of a finger. It is, the pattern according to the embodiment of the present invention is applicable of improving sensitivity of touch panel. In addition, a dummy electrode 550 is arranged between the first conductive zigzag line 330 and the second conductive zigzag line 430, so as to prevent the patterns of the first conductive unit 320 and the second conductive unit 420 from becoming visible to human eyes.

Although the present invention has been explained in relation to its preferred embodiment, it is to be understood that many other possible modifications and variations can be made without departing from the spirit and scope of the invention as hereinafter claimed.

What is claimed is:

1. A high-transparency and high-sensitivity touch pattern structure of capacitive touch panel, formed on a surface of a substrate, the touch pattern structure comprising:
a plurality of first conductive groups horizontally arranged along a first direction, each of the first conductive groups having a plurality of first conductive units, each of the first conductive units being composed of at least one first conductive zigzag line and at least one first straight line, wherein the plurality of first conductive groups are of the same layer and are disposed on the surface of the substrate;
a plurality of second conductive groups horizontally arranged along the first direction, each of the second conductive groups having a plurality of second conductive units, each of the second conductive units being composed of at least one second conductive zigzag line, wherein the second conductive groups are disposed on the surface of the substrate; and
a plurality of first traces disposed on the surface of the substrate together with the plurality of second conductive groups, each of the first traces being coupled to a corresponding one of the second conductive units;
wherein the plurality of first conductive units of the first conductive group are electrically connected together, and the plurality of first conductive units and the plurality of second conductive units form an array of capacitive sensors, each capacitive sensor having one first conductive unit and one second conductive unit.

2. The high-transparency and high-sensitivity touch pattern structure of capacitive touch panel as claimed in claim 1, wherein a dummy electrode is arranged between the first conductive unit and the second conductive unit.

3. The high-transparency and high-sensitivity touch pattern structure of capacitive touch panel as claimed in claim 2, wherein the plurality of first conductive units are arranged in a second direction, and the plurality of second conductive units are arranged in the second direction.

4. The high-transparency and high-sensitivity touch pattern structure of capacitive touch panel as claimed in claim 3, wherein the at least one first conductive zigzag line and the at least one second conductive zigzag line are arranged in the second direction, and the at least one first straight line is arranged in the first direction.

5. The high-transparency and high-sensitivity touch pattern structure of capacitive touch panel as claimed in claim 4, wherein the at least one first conductive zigzag line has an angle θ by intersecting the second direction, and the at least one second conductive zigzag line has the angle θ by intersecting the second direction.

6. The high-transparency and high-sensitivity touch pattern structure of capacitive touch panel as claimed in claim 2, wherein the at least one first conductive zigzag line is connected to one end of the at least one first straight line.

7. The high-transparency and high-sensitivity touch pattern structure of capacitive touch panel as claimed in claim 6, wherein the first conductive unit further includes a third conductive zigzag line and a fourth conductive zigzag line, and the third conductive zigzag line and the fourth conductive zigzag line are connected to a non-end location of the at least one first straight line.

8. The high-transparency and high-sensitivity touch pattern structure of capacitive touch panel as claimed in claim 7, wherein the second conductive unit further includes at least one second straight line and a fifth conductive zigzag line, the at least one second conductive zigzag line is connected to one end of the at least one second straight line, and the fifth conductive zigzag line is connected to a non-end location of the at least one second straight line.

9. The high-transparency and high-sensitivity touch pattern structure of capacitive touch panel as claimed in claim 8, wherein a dummy electrode is arranged between the third and fourth conductive zigzag lines and the fifth conductive zigzag line.

10. The high-transparency and high-sensitivity touch pattern structure of capacitive touch panel as claimed in claim 9, wherein the first conductive unit is used as a driving electrode, and the second conductive unit is used as a sensing electrode.

11. The high-transparency and high-sensitivity touch pattern structure of capacitive touch panel as claimed in claim 9, wherein the first conductive unit is used as the sensing electrode, and the second conductive unit is used as the driving electrode.

12. The high-transparency and high-sensitivity touch pattern structure of capacitive touch panel as claimed in claim 5, wherein the angle θ is greater than 0 degree and smaller than 90 degrees.

13. The high-transparency and high-sensitivity touch pattern structure of capacitive touch panel as claimed in claim 1, wherein the plurality of first conductive units, the plurality of second conductive units, and the plurality of first traces are formed of transparent conductive material.

14. The high-transparency and high-sensitivity touch pattern structure of capacitive touch panel as claimed in claim 13, wherein the transparent conductive material is indium tin oxide (ITO) or indium zinc oxide.

15. The high-transparency and high-sensitivity touch pattern structure of capacitive touch panel as claimed in claim 1, wherein the plurality of first conductive groups are not electrically connected to one another, the plurality of second conductive units are not electrically connected to one another, and each of the second conductive units is connected to a controller through a first trace.

16. The high-transparency and high-sensitivity touch pattern structure of capacitive touch panel as claimed in claim 15, wherein the controller outputs driving signals to drive the plurality of first conductive groups, respectively, and receives electrical signals sensed by the second conductive units through corresponding first traces, so as to allow the first conductive unit and the second conductive unit to form one capacitive sensor.

17. A touch panel, comprising:
a plurality of first conductive units, each of the first conductive units having zigzag line;
a plurality of second conductive units, each of the second conductive units having zigzag line; and
a controller coupled to the plurality of first conductive units and the plurality of second conductive units for outputting driving signals to drive the plurality of first conductive units, respectively, and receiving electrical signals sensed by the plurality of first conductive units, so as to allow the plurality of first conductive units and the plurality of second conductive units to form capacitive sensors.

18. The touch panel as claimed in claim 17, wherein a dummy electrode is arranged between each of the plurality of first conductive units and a corresponding second conductive unit.

19. The touch panel as claimed in claim 18, wherein each of the plurality of first conductive units includes at least one first conductive zigzag line and at least one first straight line.

20. The touch panel as claimed in claim 19, wherein each of the plurality of first conductive units further includes a third conductive zigzag line and a fourth conductive zigzag line.
